(19) United States
(12) Patent Application Publication
(10) Pub. No.: US 2005/0128894 A1
(43) Pub. Date: Jun. 16, 2005

(54) Optical pickup actuator

(75) Inventors: Sung-Hong Won, Seoul (KR); Dong-Woohn Kim, Seoul (KR); Chang-Hwan Choi, Kyunggi-Do (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/791,601

(22) Filed: Mar. 2, 2004

(30) Foreign Application Priority Data
Dec. 16, 2003 (KR) 2003-92010

(51) Int. Cl. G11B 7/00

(52) U.S. Cl. 369/44.15; 369/44.22

(57) ABSTRACT

The present invention relates, in general, to an optical pickup actuator and, more particularly, to an optical pickup actuator, in which a depression (120) is formed in a center portion of a rear surface of a wire holder (100) to be depressed, and the position of a bobbin (20) is adjusted by straining wires (30) while a center portion of a printed circuit board (200), closely attached to the rear surface of the wire holder, is pressurized using a control screw (300) to allow the printed circuit board to be arcuately deformed.

### BACKGROUND OF THE INVENTION

1. Field of the Invention

The present invention relates, in general, to optical pickup actuators and, more particularly, to an optical pickup actuator, which improves the structures of a holder and a printed circuit board to which wires are fixedly attached, so that the wires can be soldered at exact locations, and so that gaps between magnets and coils can be adjusted through the adjustment of the positions of the wires, thus keeping the gaps uniform.

2. Description of the Related Art

Generally, an optical pickup is a device mounted on both a main shaft and a sub-shaft provided on a deck of an optical recording and reproducing apparatus to record signals on a variety of optical disks or reproduce the signals recorded on the optical disks while reciprocating along an axial direction. Typically, the optical pickup is divided into a pickup base and an actuator.

The pickup base is directly mounted on both the main shaft and the sub-shaft provided on the deck of the optical recording and reproducing apparatus, and reciprocates along the axial direction. In the pickup base, there are installed a laser diode for emitting light beams, a beam splitter for reflecting the light beams emitted from the laser diode in a direction of an optical disk, and a photodetector for receiving the light beams reflected from the optical disk and converting the light beams into electrical signals.

The actuator is movably installed on a top surface of the pickup base and functions to focus light beams on a single point on the optical disk through an object lens while moving together with the base.

For slim-type or portable-type optical recording and reproducing apparatuses, in the optical pickup actuators thereof, the central points of an object lens and a driving force do not coincide with each other due to the structural characteristics of the optical pickup actuators, so that defects due to subsidiary resonance frequently occur. Actually, because serious problems due to the subsidiary resonance defects occur at the time of production, measures to cope with the subsidiary resonance defects are required.

Properly, in order to solve the subsidiary resonance defects, several schemes, such as a magnetic attenuation apparatus or a mechanical attenuation apparatus, can be used. However, a scheme for adding gel between a wire holder and a printed circuit board to attenuate subsidiary resonance has been generally used.

FIGS. 1 and 2 illustrate an example of a conventional optical pickup actuator to which a scheme for adding gel to attenuate subsidiary resonance is applied.

Referring to FIGS. 1 and 2, in the conventional optical pickup actuator, a bobbin 20 provided with an object lens 22 is installed on a support plate 10 so that the position of the bobbin 20 can be finely adjusted in a focusing direction, that is, a vertical direction, and in a tracking direction, that is, a horizontal direction.

On a front portion of a top surface of the support plate 10, a pair of opposite yokes 12, spaced apart from each other by a predetermined distance, are formed to be extended upward. A pair of magnets, 14 which are permanent magnets, are symmetrically attached to opposite surfaces of the pair of yokes 12.

Further, a wire holder 40 is fixedly mounted on a rear portion of the top surface of the support plate 10, and a printed circuit board (PCB) 50 is closely attached to a rear surface of the wire holder 40.

Tension parts 54 are formed in upper and lower portions of both ends of the PCB 50, respectively. The tension parts 54 are made to be elastic by forming a plurality of notches 52 therethrough. Further, grooves are formed in the rear surface of the wire holder 40 at locations corresponding to those of the tension parts 54 of the PCB 50. Gel 60 functioning as a damper is filled into spaces between the wire holder 40 and the tension parts 54 through the grooves so as to attenuate. subsidiary resonance.

The bobbin 20 has an approximately rectangular frame shape to have a central hollow portion. A tracking coil 24 is wound around the front portion of the bobbin 20 and a focusing coil 26 is wound around the side portion of the bobbin 20.

Such a bobbin 20 is installed on the top surface of the support plate 10 to be finely movable through wires 30.

That is, the wires 30 are connected to the upper and lower portions of both sides of the bobbin 20 through soldering. The wires 30 are horizontally extended to penetrate through the wire holder 40 and then fixed to the corresponding tension parts 54 of the PCB 50, which is attached to the rear surface of the wire holder 40, through soldering. Therefore, the bobbin 20 is elastically supported by a total of four wires 30 and, thus, it can be finely vertically or horizontally moved.

In this case, the bobbin 20 is installed so that the tracking coil 24 and the focusing coil 26 are located between the magnets 14 provided on the support plate 10. At this time, it is important to keep gaps uniform between the magnets and the coils.

The operation of the conventional optical pickup actuator having the above construction is described in brief. If a current supplied to the PCB 50 is applied to the focusing coil 26 or the tracking coil 24 through the wires 30, the object lens 22 is adjusted in the focusing or tracking direction while the bobbin 20 is moved by an electromagnetic force between the coil and the magnets 14 depending on the flow of the current.

The conventional optical pickup actuator, constructed and operated as described above, is problematic in that it is difficult to fix the wires to the tension parts of the PCB through soldering and to keep the gaps uniform between the magnets and the coils.

In order to describe the above problem in detail, a method of adjusting and fixing the positions of the wires is described with reference to FIG. 3.

When the conventional optical pickup actuator is assembled, one ends of the corresponding wires 30 are fixed to the upper and lower portions of the both sides of the bobbin 20 through soldering, and the other ends of the wires 30 are assembled to sequentially penetrate through the wire holder 40, the gel 60 and the PCB 50.

Thereafter, the position of the bobbin 20 is adjusted, so that the gaps between the coils placed on the bobbin 20 and the magnets 14 placed on the support plate 10 are kept uniform. After the position of the bobbin 20 is adjusted, the wires 30 are fixed to the tension parts 54 formed on the PCB 50 through soldering.

However, when a total of four wires are fixed to the corresponding tension parts of the PCB through soldering, the wires are not fixed at exact locations due to elasticity of the tension parts formed at the PCB but are vibrated, as represented by imaginary lines in FIG. 3.

Further, the conventional optical pickup actuator is problematic in that a case where the wires are not fixed at exact locations frequency occurs due to differences between the times required for solder applied on the four tension parts to solidify, in addition to the vibration of the tension parts at the time of soldering.

As described above, the conventional optical pickup actuator is problematic in that, as a total of four wires are fixed to the corresponding tension parts through soldering, a position error is generated, so that the position of the bobbin supported by the wires is changed and offset, thus varying the gaps between the coils and the magnets.

### SUMMARY OF THE INVENTION

Accordingly, the present invention has been made keeping in mind the above problems occurring in the prior art, and an object of the present invention is to provide an optical pickup actuator, which prevents tension parts from being vibrated when wires are fixed to the tension parts of a PCB through soldering, thus enabling the wires to be fixed at the exact locations of the tension parts.

Another object of the present invention is to provide an optical pickup actuator, which can adjust the positions of the wires by varying the positions of the tension parts of the PCB after the wires are fixed to the tension parts of the PCB, thus keeping gaps uniform between coils and magnets.

A further object of the present invention is to provide an optical pickup actuator, which freely and precisely adjusts the gaps between the coils and the magnets, thus removing defects due to subsidiary resonance.

In order to accomplish the above object, the present invention provides an optical pickup actuator, comprising a support plate provided with a pair of yokes extended upward and a pair of magnets oppositely attached to opposite surfaces of the pair of yokes; a bobbin placed on a top surface of the support plate, and provided with an object lens located on a portion thereof and a tracking coil and a focusing coil wound on an outer side of the bobbin, the coils being installed to be located between the magnets; a wire holder fixed to a portion of the top surface of the support plate and provided with a depression formed in a center portion of a rear surface thereof to be depressed compared to both ends of the rear surface, the depression having a screw receiving hole formed in a center portion thereof; a printed circuit board closely attached to the rear surface of the wire holder and provided with a screw hole formed through a center portion thereof; a plurality of wires provided with first ends fixed to upper and lower portions of both sides of the bobbin and second ends extended from the first ends, the second ends penetrating through the wire holder and the printed circuit board and being fixed to a rear surface of the printed circuit board so as to elastically support the bobbin; a control screw engaged with the screw receiving hole of the wire holder after penetrating through the screw hole of the printed circuit board, the control screw allowing the printed circuit board to be arcuately bent while pressurizing a center portion of the printed circuit board to be located in the depression formed in the wire holder, thus deforming the printed circuit board to allow both ends thereof to be away from the wire holder; and gel functioning as a damper filled into spaces between the both ends of the arcuately bent printed circuit board and the wire holder.

In the optical pickup actuator, the wire holder may be provided with assembly bosses formed on opposite sides around the screw receiving hole in the rear surface of the wire holder to be protruded from the wire holder, and the printed circuit board may be provided with assembly holes formed therethrough at locations corresponding to those of the assembly bosses, the assembly holes being formed lengthwise in a transverse direction.

In the optical pickup actuator, the control screw may be designed so that a header part thereof pressurizes the printed circuit board and is then fixed to the printed circuit board through bonding or soldering so as to prevent the control screw from being disengaged after engagement of the control screw has been completed.

In the optical pickup actuator, the printed circuit board may be integrally provided with tension parts in upper and lower portions of the both ends of the printed circuit board to be made elastic by cutting away parts of the both ends thereof, and the wires may be fixedly attached to the corresponding tension parts.

Further, the present invention provides an optical pickup actuator, in which a bobbin provided with an object lens is elastically supported by a plurality of wires penetrating through a wire holder and being fixed to a printed circuit board, comprising a wire holder provided with a depression formed in a center portion of a rear surface thereof to be depressed compared to both ends of the rear surface, a printed circuit board closely attached to the rear surface of the wire holder, and provided with both ends to which corresponding wires are connected, and pressurizing means for allowing the printed circuit board to be arcuately bent while pressurizing a center portion of the printed circuit board to be located in the depression of the wire holder, the pressurizing means being fixed to the printed circuit board so as to maintain a bent state of the printed circuit board.

In the optical pickup actuator, the pressurizing means may be a control screw for pressurizing the printed circuit board through a header part thereof while penetrating through the printed circuit board and being engaged with the wire holder.

In the optical pickup actuator, the pressurizing means may comprise a control screw sequentially penetrating through the printed circuit board and the wire holder, and a nut engaged with the control screw on a front surface of the wire holder.

In the optical pickup actuator, the pressurizing means may comprises a control screw sequentially penetrating through the wire holder and the printed circuit board from a front surface of the wire holder, and a nut engaged with the control screw on a rear surface of the printed circuit board.

In the optical pickup actuator, the pressurizing means may be an adhesive for fixing parts of both the printed circuit board and the wire holder to each other to maintain a deformed printed circuit board after the printed circuit board is pressurized using a separate jig to be arcuately deformed.

The optical pickup actuator may further comprise gel functioning as a damper filled into spaces between the both ends of the arcuately bent printed circuit board and the wire holder.

In the optical pickup actuator, the printed circuit board may be integrally provided with tension parts in upper and lower portions of the both ends of the printed circuit board to be made elastic by cutting away parts of the both ends thereof, and the wires are fixedly attached to the corresponding tension parts.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a conventional optical pickup actuator;

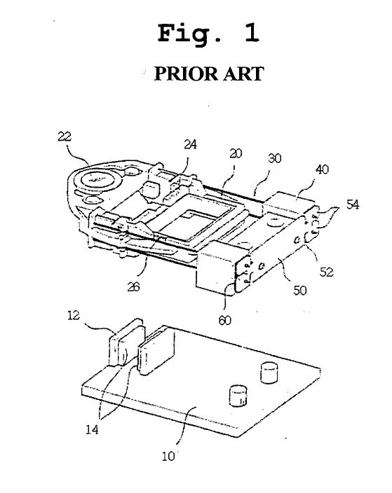

FIG. 2 is a top view of the conventional optical pickup actuator;

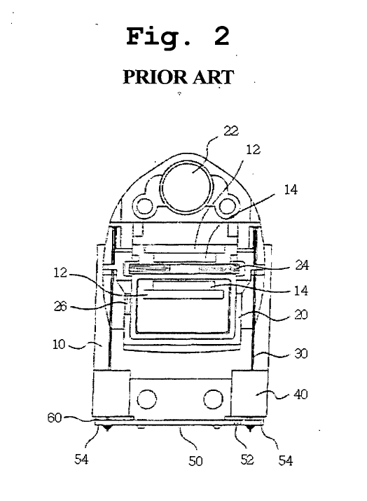

FIG. 3 is a view showing an assembly process to describe a conventional method of adjusting and fixing the positions of wires;

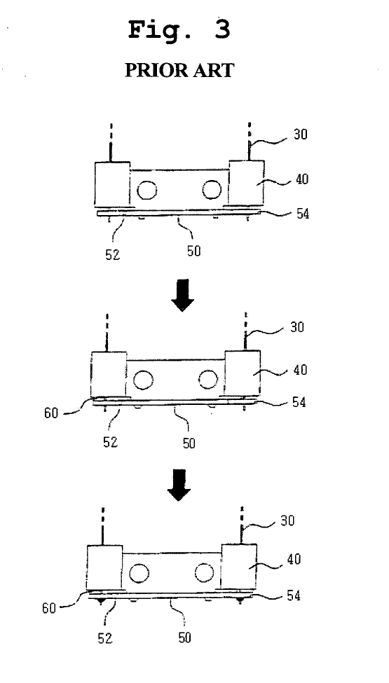

FIG. 4 is an exploded perspective view of an optical pickup actuator according to the present invention;

FIG. 5 is a top view showing the optical pickup actuator of the present invention;

FIG. 6 is a view showing an assembly process to describe a method of adjusting and fixing the positions of wires of the present invention;

FIG. 7 is a top view showing a means for pressing a PCB in the optical pickup actuator according to another embodiment of the present invention;

FIG. 8 is a top view showing a means for pressing a PCB in the optical pickup actuator according to a further embodiment of the present invention; and

FIG. 9 is a top view showing a means for pressing a PCB in the optical pickup actuator according to still another embodiment of the present invention.

### DESCRIPTION OF THE PREFERRED EMBODIMENTS

Hereinafter, embodiments of the present invention will be described in detail with reference to the attached drawings.

Reference now should be made to the drawings, in which the same reference numerals are used throughout the different drawings to designate the same or similar components.

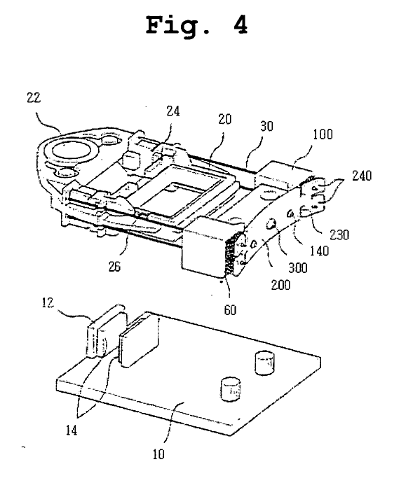

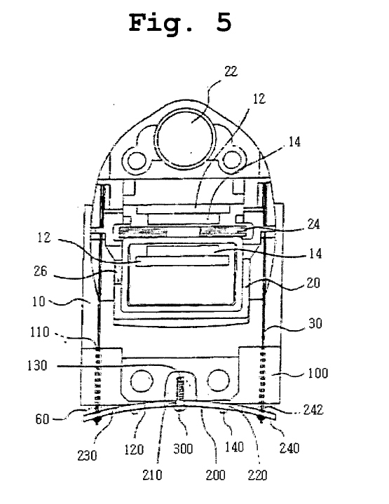

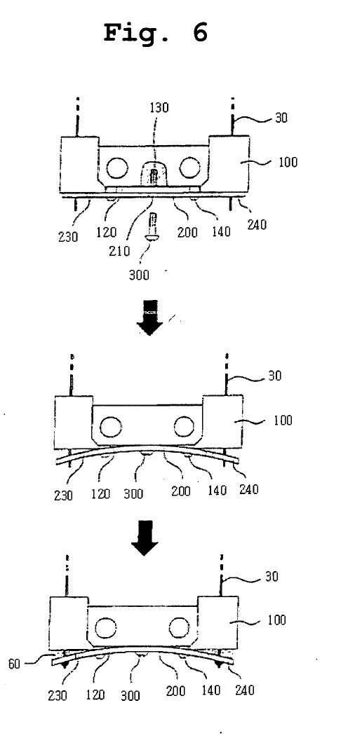

FIG. 4 is an exploded perspective view of an optical pickup actuator according to the present invention, FIG. 5 is a top view showing the optical pickup actuator of the present invention, and FIG. 6 is a view showing an assembly process to describe a method of adjusting and fixing the positions of wires of the present invention.

Referring to FIGS. 4 to 6, in the optical pickup actuator of the present invention, a bobbin 20 provided with an object lens 22 is installed on a support plate 10 so that the position of the bobbin 20 can be finely adjusted in a focusing direction, that is, a vertical direction, and in a tracking direction, that is, a horizontal direction.

On a front portion of a top surface of the support plate 10, a pair of opposite yokes 12, spaced apart from each other by a predetermined distance, are formed to be extended upward. A pair of magnets, 14 which are permanent magnets, are symmetrically attached to opposite surfaces of the pair of yokes 12.

The bobbin 20 has an approximately rectangular frame shape to have a central hollow portion. A tracking coil 24 is wound around the front portion of the bobbin 20 and a focusing coil 26 is wound around the side portion of the bobbin 20.

Further, the bobbin 20 is installed on the top surface of the support plate 10 to be finely movable through a plurality of wires 30. In this case, the bobbin 20 is installed so that winding parts of the tracking coil 24 and the focusing coil 26 are located between the magnets 14 provided on the support plate 10. At this time, gaps between the magnets and the coils should be kept uniform.

A method of elastically supporting the bobbin 20 by the wires 30 is described in detail. The wires 30 are connected to the upper and lower portions of both sides of the bobbin 20 through soldering. The Extended parts of the wires 30 penetrate through a wire holder 100 and are then fixed to a printed circuit board (PCB) 200 through soldering.

In this way, the bobbin 20 is elastically supported to be finely movable by a total of four wires 30. Further, if the positions of the wires 30 are adjusted forward or backward, the position of the bobbin 20 is also changed forward or backward.

The wire holder 100 is fixedly mounted on the top surface of the support plate 10.

Further, wire passing holes 110 are formed in upper and lower portions of both sides of the wire holder 100 to allow the wires 30 to penetrate therethrough. A depression 120 is formed in a center portion of a rear surface of the wire holder 100 to be depressed inward compared to both ends of the wire holder 100. Further, a screw receiving hole 130 is formed in a center portion of the depression 120. Assembly bosses 140 are formed on both side edges of the depression 120 to be protruded backward.

The PCB 200 is closely attached to the rear surface of the wire holder 100.

A screw hole 210 is formed through a center portion of the PCB 200 corresponding to that of the screw receiving hole 130 of the wire holder 100 to allow a control screw, which will be described later, to be engaged with the screw hole 210. Further, assembly holes 220 are formed on the opposite sides around the screw hole 210 of the PCB 200 at locations corresponding to those of the assembly bosses 140 of the wire holder 100. At this time, the assembly holes 220 are preferably formed lengthwise in a transverse direction of the PCB so that the PCB 200 is movable along the assembly bosses 140.

Further, tension parts 240 are integrally formed in upper and lower portions of both ends of the PCB 200, wherein the tension parts 240 are made to be elastic by the action of a plurality of notches 230 formed by cutting away parts of the both ends of the PCB 200. Wire holes 242 into which the wires 30 are inserted are formed through the PCB 200 at locations of the tension parts 240 corresponding to those of the wire passing holes 110 of the wire holder 100.

According to the present invention, the control screw 300 is assembled so that it penetrates through the screw hole 210 of the PCB 200 and is then engaged with the screw receiving hole 130 of the wire holder 100.

When the control screw 300 is engaged with the screw receiving hole 130, a header part thereof pressurizes the PCB 20, so that the center portion of the PCB 200 is bent toward the depression 120 of the wire holder 100 and located in the depression 120 due to the pressure. Then, as the PCB 200 is arcuately bent, both ends thereof are bent to be away from the wire holder 100.

Therefore, in the present invention, the levels of bending of the PCB 200 differ depending on a length by which the control screw 300 is engaged. As the bending level is high, the wires 30 fixed to the tension parts 240 of the PCB 200 are gradually strained backward, and the bobbin 20 is moved backward in proportion to the strain of the wires 30. Therefore, it is possible to adjust the gaps between the coils of the bobbin 20 and the magnets 14 of the support plate 10. Properly, it is preferable to control the bending level of the PCB 200 at a location where the gaps between the coils and the magnets are kept uniform.

In this case, it is preferable that, after the engagement of the control screw 300 has been completed, the header part of the control screw 300 is fixed to the PCB 200 through bonding or soldering so as to prevent the disengagement of the control screw 300.

According to the present invention, spaces between both ends of the PCB 200 arcuately bent and the wire holder 100 are filled with typical gel 60 functioning as a damper.

The assembly of the optical pickup actuator of the present invention having the above construction is described below.

First, a total of four wires 30 are connected to the upper and lower portions of both sides of the bobbin 20, respectively, through soldering.

Further, the wire holder 100 is fixed to the top surface of the support plate 10, and then the PCB 200 is attached to the rear surface of the wire holder 100. That is, the PCB 200 is closely attached to the rear surface of the wire holder 100 so that the assembly bosses 140 formed on the rear surface of the wire holder 100 are inserted into the assembly holes 220 formed in the PCB 200. Thereafter, the control screw 300 penetrates through the screw hole 210 of the PCB 200 and is then engaged with the screw receiving hole 130 formed in the wire holder 100. At this time, the control screw 300 is engaged until it pressurizes the PCB 200.

Thereafter, the extended parts of the wires 30 connected to the bobbin 20 penetrate through the wire holder 100 and are then fixed to the corresponding tension parts 240 of the PCB 200 through soldering. At this time, the bobbin 20 is installed so that the tracking coil 24 and the focusing coil 26 of the bobbin 20 are located between the pair of magnets 14 provided on the support plate 10.

Then, as shown in FIG. 6, the PCB 200 is allowed to be arcuately bent while the control screw 300 is slowly tightened, so that the wires 30 fixed to both ends of the PCB 200, that is, the tension parts 240, are strained backward. Therefore, the bobbin 20 is moved backward together with the wires 30. Properly, if the bobbin 20 is moved and then the gaps between the tracking or focusing coil and the magnets 14 of the support plate 10 are kept uniform, an operation of tightening the control screw 300 needs to be stopped.

After the adjustment of the position of the bobbin 20 has been completed, spaces between the wire holder 100 and the tension parts 240 of the PCB 200 are filled with the gel 60 functioning as a damper. After all operations have been completed, the header part of the control screw 300 is finally fixed to the PCB 200 through soldering or bonding.

The driving of the optical pickup actuator of the present invention constructed and assembled as described above is described below in brief.

The optical pickup actuator of the present invention is driven so that, when a current supplied to the PCB 200 is applied to the focusing coil 26 or the tracking coil 24 through the wires 30, the object lens 22 is finely adjusted in the focusing or tracking direction while the bobbin 20 is moved by an electromagnetic force between the coil and the magnets 14 depending on the flow of the current.

The optical pickup actuator of the present invention constructed and operated as described above has a plurality of advantages.

First, the present invention is advantageous in that, when the wires connected to the bobbin are fixed to the corresponding tension parts of the PCB through soldering, the tension parts are not moved while being fully attached to the rear surface of the wire holder, thus enabling a soldering operation to be performed at exact locations.

Further, the present invention is advantageous in that the wires are first fixed to the PCB through soldering and then strained while the control screw is tightened, so that the position of the bobbin is adjusted, thus keeping the gaps uniform between the tracking or focusing coil placed on the bobbin and the magnets placed on the support plate.

Further, the present invention is advantageous in that, when the positions of the gaps are erroneously changed and the gaps are irregularly arranged during assembly, the positions of the gaps can be readjusted by changing the position of the bobbin while loosening and tightening the control screw again.

Moreover, the present invention is advantageous in that, when subsidiary resonance is measured after the gel is filled into spaces between the wire holder and the PCB, a distance between the wire holder and the PCB is adjusted and thus the position of the bobbin can be finely adjusted, so that the amount of subsidiary resonance is adjusted to a suitable level or less. Therefore, most defects occurring due to subsidiary resonance can be repaired.

In the meantime, the embodiment of the present invention is constructed so that the center portion of the PCB is pressurized using the control screw and then the PCB is bent arcuately. However, this construction is only an embodiment of the present invention. Any schemes provided with a pressurizing means capable of pressurizing the center portion of the PCB to arcuately deform the PCB and maintain the deformed PCB can be freely applied to the present invention.

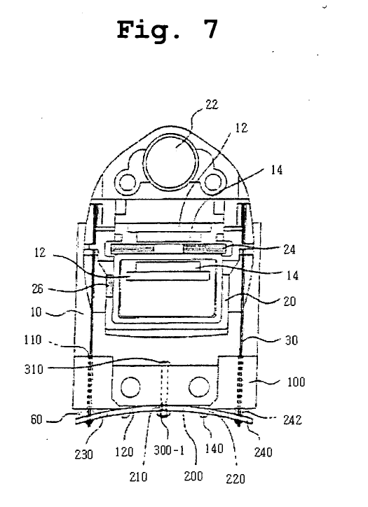

FIGS. 7 to 9 are views showing a means for pressurizing the PCB according to other embodiments of the present invention. Only differences between the above embodiment and other embodiments are described below.

Referring to FIG. 7, the means for pressurizing the PCB applicable to the present invention is constructed in such a way that a control screw 300-1 sequentially penetrates the PCB 200 and the wire holder 100 from the rear surface of the PCB 200, and a nut 310 is engaged with the control screw 300-1 on the front surface of the wire holder 100, so that the control screw 300-1 can pressurize the PCB 200 while loosening and tightening the nut 310 on the control screw 300-1.

The pressurizing means can be constructed so that, after the nut 310 is first fixed to the wire holder 100 through soldering or bonding, the control screw 300-1 having sequentially penetrated through the PCB 200 and the wire holder 100 is engaged with the nut 310, and pressurizes the PCB 200 while loosening and tightening the control screw 300-1.

After the engagement of the screw with the nut has been completed, the header part of the screw 300-1 needs to be fixed to the PCB 200 through bonding or soldering so as to prevent the disengagement of the screw.

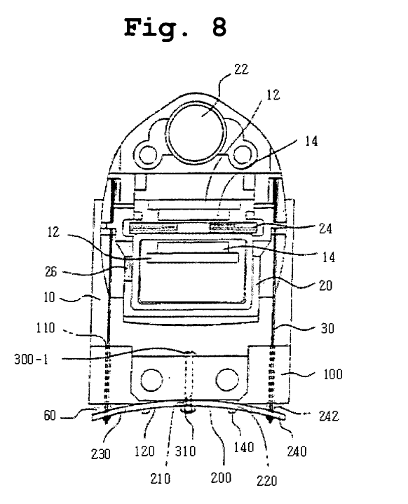

Next, referring to FIG. 8, the PCB pressurizing means applicable to the present invention is constructed in such a way that the control screw 300-1 sequentially penetrates through the wire holder 100 and the PCB 200 from the front surface of the wire holder 100, and the nut 310 is engaged with the control screw 300-1 on the rear surface of the PCB 200, so that the control screw 300-1 can pressurize the PCB 200 while loosening and tightening the nut 310 on the control screw 300-1.

The pressurizing means can be constructed so that, after the nut 310 is first fixed to the PCB 200 through soldering or bonding, the control screw 300-1 having sequentially penetrated through the wire holder 100 and the PCB 200 is engaged with the nut 310 and pressurizes the PCB 200 while loosening and tightening the control screw 300-1.

After the engagement of the screw with the nut has been completed, the header part of the screw 300-1 needs to be fixed to the wire holder 100 through bonding or soldering so as to prevent the disengagement of the screw.

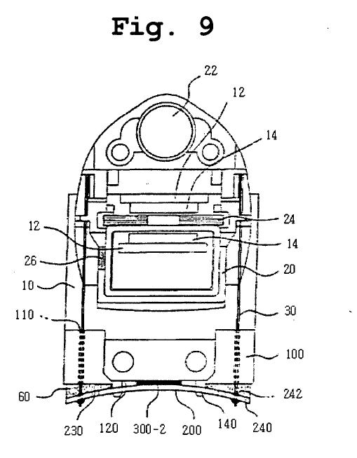

Next, referring to FIG. 9, the PCB pressurizing means applicable to the present invention can be constructed so that parts of both the PCB 200 and the wire holder 100 are fixed to each other using an adhesive 300-2, such as a bond, while the PCB 200 is bent after the PCB 200 is pressurized using a separate jig (not shown).

Although not shown in detail, for the PCB pressurizing means applicable to the present invention, an operating principle of a typical nipple can be employed, in addition to the above-described embodiments.

Further, the optical pickup actuator of the present invention can be applied to all types of optical pickup units and optical recording and reproducing apparatuses.

As described above, the present invention provides an optical pickup actuator, in which wires are soldered after tension parts of a PCB are fixed to be unable to move, so that the wires can be soldered and fixed to exact locations.

Further, the present invention is advantageous in that, since the wires are first fixed and then the PCB is deformed to precisely adjust the position of a bobbin while the wires are strained or released, gaps between coils provided on the bobbin and magnets provided on a support plate can be precisely adjusted, thus keeping the gaps optimum.

Further, the present invention is advantageous in that, since then the position of the bobbin is precisely adjusted when subsidiary resonance is measured after gel is filled, the amount of subsidiary resonance can be adjusted to a suitable level or less, thus enabling most defects occurring due to subsidiary resonance to be repaired.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An optical pickup actuator, comprising:
a support plate provided with a pair of yokes extended upward and a pair of magnets oppositely attached to opposite surfaces of the pair of yokes;
a bobbin placed on a top surface of the support plate, and provided with an object lens located on a portion thereof and a tracking coil and a focusing coil wound on an outer side of the bobbin, the coils being installed to be located between the magnets;
a wire holder fixed to a portion of the top surface of the support plate and provided with a depression formed in a center portion of a rear surface thereof to be depressed compared to both ends of the rear surface, the depression having a screw receiving hole formed in a center portion thereof;
a printed circuit board closely attached to the rear surface of the wire holder and provided with a screw hole formed through a center portion thereof;
a plurality of wires provided with first ends fixed to upper and lower portions of both sides of the bobbin and second ends extended from the first ends, the second ends penetrating through the wire holder and the printed circuit board and being fixed to a rear surface of the printed circuit board so as to elastically support the bobbin;
a control screw engaged with the screw receiving hole of the wire holder after penetrating through the screw hole of the printed circuit board, the control screw allowing the printed circuit board to be arcuately bent while pressurizing a center portion of the printed circuit board to be located in the depression formed in the wire holder, thus deforming the printed circuit board to allow both ends thereof to be away from the wire holder; and
gel functioning as a damper filled into spaces between the both ends of the arcuately bent printed circuit board and the wire holder.

2. The optical pickup actuator according to claim 1, wherein:
the wire holder is provided with assembly bosses formed on opposite sides around the screw receiving hole in the rear surface of the wire holder to be protruded from the wire holder; and
the printed circuit board is provided with assembly holes formed therethrough at locations corresponding to those of the assembly bosses, the assembly holes being formed lengthwise in a transverse direction.

3. The optical pickup actuator according to claim 1, wherein the control screw is designed so that a header part thereof pressurizes the printed circuit board and is then fixed to the printed circuit board through bonding or soldering so as to prevent the control screw from being disengaged after engagement of the control screw has been completed.

4. The optical pickup actuator according to claim 1, wherein the printed circuit board is integrally provided with tension parts in upper and lower portions of the both ends of the printed circuit board to be made elastic by cutting away parts of the both ends thereof, and the wires are fixedly attached to the corresponding tension parts.

5. An optical pickup actuator, in which a bobbin provided with an object lens is elastically supported by a plurality of wires penetrating through a wire holder and being fixed to a printed circuit board, comprising:
a wire holder provided with a depression formed in a center portion of a rear surface thereof to be depressed compared to both ends of the rear surface;
a printed circuit board closely attached to the rear surface of the wire holder, and provided with both ends to which corresponding wires are connected; and
pressurizing means for allowing the printed circuit board to be arcuately bent while pressurizing a center portion of the printed circuit board to be located in the depression of the wire holder, the pressurizing means being fixed to the printed circuit board so as to maintain a bent state of the printed circuit board.

6. The optical pickup actuator according to claim 5, wherein the pressurizing means is a control screw for pressurizing the printed circuit board through a header part thereof while penetrating through the printed circuit board and being engaged with the wire holder.

7. The optical pickup actuator according to claim 5, wherein the pressurizing means comprises a control screw sequentially penetrating through the printed circuit board and the wire holder, and a nut engaged with the control screw on a front surface of the wire holder.

8. The optical pickup actuator according to claim 5, wherein the pressurizing means comprises a control screw sequentially penetrating through the wire holder and the printed circuit board from a front surface of the wire holder, and a nut engaged with the control screw on a rear surface of the printed circuit board.

9. The optical pickup actuator according to claim 5, wherein the pressurizing means is an adhesive for fixing parts of both the printed circuit board and the wire holder to each other to maintain a deformed printed circuit board after the printed circuit board is pressurized using a separate jig to be arcuately deformed.

10. The optical pickup actuator according to claim 5, further comprising gel functioning as a damper filled into spaces between the both ends of the arcuately bent printed circuit board and the wire holder.

11. The optical pickup actuator according to claim 5, wherein the printed circuit board is integrally provided with tension parts in upper and lower portions of the both ends of the printed circuit board to be made elastic by cutting away parts of the both ends thereof, and the wires are fixedly attached to the corresponding tension parts.
